(19) United States
(12) Patent Application Publication
(10) Pub. No.: US 2026/0038935 A1
(43) Pub. Date: Feb. 5, 2026

(54) HIGH-VOLTAGE BATTERY FOR MOTOR VEHICLE

(71) Applicant: Dr. Ing. h.c. F. Porsche Aktiengesellschaft, Stuttgart (DE)

(72) Inventors: Christian Porstendörfer, Stuttgart (DE); David Ullmann, Rutesheim (DE); David Schmid, Niefern-Öschelbronn (DE)

(73) Assignee: Dr. Ing. h.c. F. Porsche Aktiengesellschaft, Stuttgart (DE)

(21) Appl. No.: 19/283,599

(22) Filed: Jul. 29, 2025

(30) Foreign Application Priority Data
Jul. 30, 2024 (DE) 10 2024 121 602.6

(51) Int. Cl. H01M 50/242; H01M 10/613; H01M 10/6557; H01M 50/204; H01M 50/249; H01M 50/291; H01M 50/293

(52) U.S. Cl. CPC H01M 50/242; H01M 10/613; H01M 10/6557; H01M 50/249; H01M 50/291; H01M 50/293; H01M 50/204

(57) ABSTRACT

A high-voltage battery includes a plurality of cells and at least one crushing pad arranged between the plurality of cells. The crushing pad is composed of an aluminum composite foil and includes a plurality of conduits formed in the aluminum composite foil. The crushing pad is structured so that channels for guiding coolant between adjacent cells are formed on both sides of the crushing pad. The channels extend along the sealing seams and between the adjacent conduits. A motor vehicle may include the high-voltage battery.

### CROSS-REFERENCE TO RELATED APPLICATION

This application claims priority to German Patent Application No.: 10 2024 121 602.6, filed Jul. 30, 2024, the content of such application being incorporated by reference herein in its entirety.

### FIELD OF THE INVENTION

The present invention relates to a high-voltage battery. The present invention further relates to its manufacture and use, as well as a corresponding motor vehicle.

### BACKGROUND OF THE INVENTION

In the field of high-voltage batteries (HVB) for electric vehicles, efficient and safe arrangement as well as the protection of the individual battery cells is of critical importance. The battery cells are typically compiled in a so-called battery stack, in which the individual cells are separated from each other by intercellular materials. These materials perform several critical functions that are essential for the performance and longevity of the battery.

The primary function of the cell intermediate material is to equalize tolerances through compression. This allows for an adjustment to slight size differences of the individual cells and ensures a firm and secure fit of the cells in the battery network. A further task of the cell intermediate material is to apply defined biasing forces on the cells in order to stabilize the overall package.

A further important aspect is the inclusion of volume changes of the battery cell that depend on both state of charge (SoC) as well as state of health (SoH). These volume changes must be compensated in order to maintain the mechanical integrity and electrical connection within the battery pack.

In addition, the cell intermediate materials serve for electrical and thermal insulation between the battery cells. This insulation prevents short-circuits and supports the heat distribution within the battery pack, even in case of high power requirements.

In an immersion-cooled HVB, the flow of the coolant between the battery cells also plays an important role. This flow improves heat dissipation and contributes to an even tempering of the battery pack.

Until now, foams, elastomers, or felting agents have predominantly been used as cell intermediate materials. These materials provide a certain amount of suspension and insulation.

A compressible separation element for insertion between two battery cells of a battery comprising a gas chamber is known from DE102021115536A1, which is incorporated by reference herein.

FR3138738A1, which is incorporated by reference herein, discloses compressible spacer pads for insertion between two battery cells of a battery. These are filled with a fluid, in particular air.

DE102021206937A1, which is incorporated by reference herein, discloses an at least partially compressible pressure equalization element for insertion between two battery cells in order to bias them. The pressure equalization element comprises surface structures that are configured in a manner opposite to corresponding structures on the battery cells.

### SUMMARY OF THE INVENTION

One problem is that known cell intermediate materials show significant settling and creep effects over time. These material changes are due to the mechanical stresses and thermal cycles to which they are subjected during normal operation of the battery. Derivative settling and creep effects cause the material to lose its elasticity and reduce its thickness permanently. This directly affects the functionality of the battery system:

The mechanical stability may be compromised, even biasing force may be reduced, and efficient thermal insulation between cells may be degraded as cells age.

A further problem arises from the chemical and physical interaction of the cell intermediate materials, in particular in systems with immersion-cooled batteries. Conventional materials may react with or be impaired by the cooling liquids, resulting in further degradation of the materials. Not only does this adversely affect the life and performance of the battery, but it can also create maintenance and safety risks.

Also, the flow of the coolant between the cells is often insufficient in conventional systems. While the materials used provide for pores or channels for the flow of the coolant, they are not always uniform or sufficiently sized. Uneven temperature distribution within the battery pack may affect the efficiency and life of the battery cells and may increase the risk of overheating.

The problem described above may be solved by the high-voltage battery, methods for its manufacture and use, and the motor vehicle described herein.

The approach described herein has the advantage that it significantly reduces the material fatigue caused by settling and creep effects. This imparts a stable mechanical structure to a HVB according to the invention, because its components maintain their elasticity and thickness over the entire lifecycle of the battery. In particular, even biasing forces are ensured, which improves the electrical connection of the cells.

A further advantage is the improved chemical and physical resistance to coolants. The materials used according to the invention do not interact with typical cooling liquids and exhibit a higher resistance to degradation. This prolongs the life expectancy of the battery.

Moreover, heat dissipation and even temperature control of the battery pack is optimized. The flow of the coolant between the cells is cleverly dissolved, allowing for more even cooling. This leads to a more stable temperature distribution within the battery pack, which increases cell efficiency and lifespan and mitigates the risk of overheating.

Overall, these improvements contribute to a higher reliability and efficiency of the high-voltage battery by strengthening the mechanical and thermal integrity of the entire system.

Further advantageous configurations of the invention are specified in the dependent claims.

### BRIEF DESCRIPTION OF THE DRAWINGS

FIG. 1 shows the longitudinal cross-section of a conventional HVB as in the delivery state (100% SoH).

FIG. 2 shows a corresponding section view of the HVB at the end of its life (50% SoH).

FIG. 3 shows a single cell of the HVB biased between two crushing pads in the delivery state.

FIG. 4 shows the single cell at the end of its life.

FIG. 5, using a series of curves, illustrates the correlation of the pressure exerted by a conventional crushing pad with its relative compression as well as the material-typical hysteresis between compression and decompression.

FIG. 6 shows the cross-section of the crushing pad arranged between two cells of a HVB according to the invention.

FIG. 7 shows the longitudinal section of the same crushing pad in the plane of its sealing seams.

FIG. 8 shows a longitudinal section of the HVB according to the invention, corresponding to FIG. 1 in the delivery state.

FIG. 9 shows a longitudinal section of the HVB according to the invention corresponding to FIG. 2 at the end of its life.

FIG. 10, in a common coordinate system, shows the pressure distribution of a conventional crushing pad and a pad filled with air according to the invention, as a comparison.

FIG. 11, using curves obtained over 1,000 test cycles, shows the correlation of the pressure exerted by the pad according to the invention with its thickness.

### DETAILED DESCRIPTION OF THE INVENTION

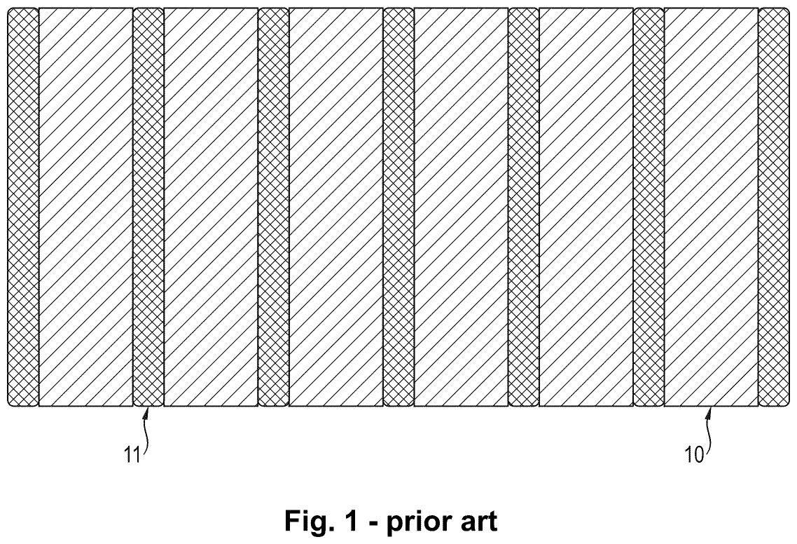

FIGS. 1-5 depict information that is known to the Applicant, however that information is provided for comparison purposes and is not necessarily admitted prior art to the claimed invention.

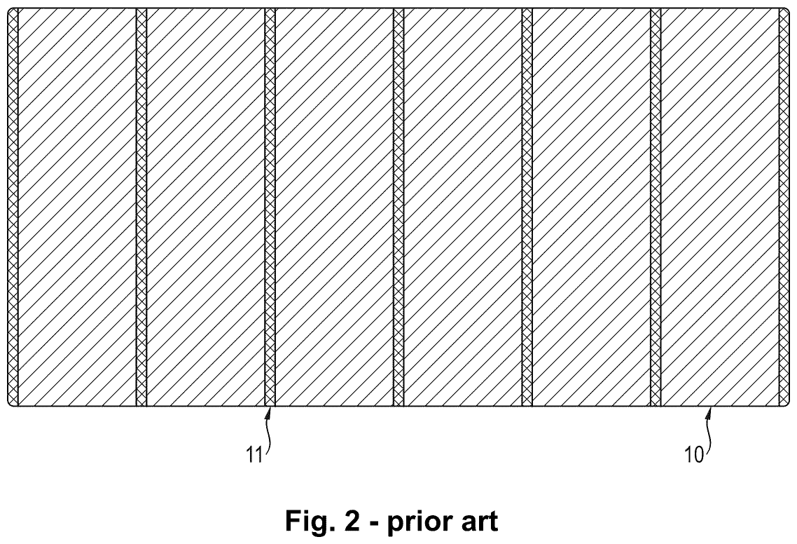

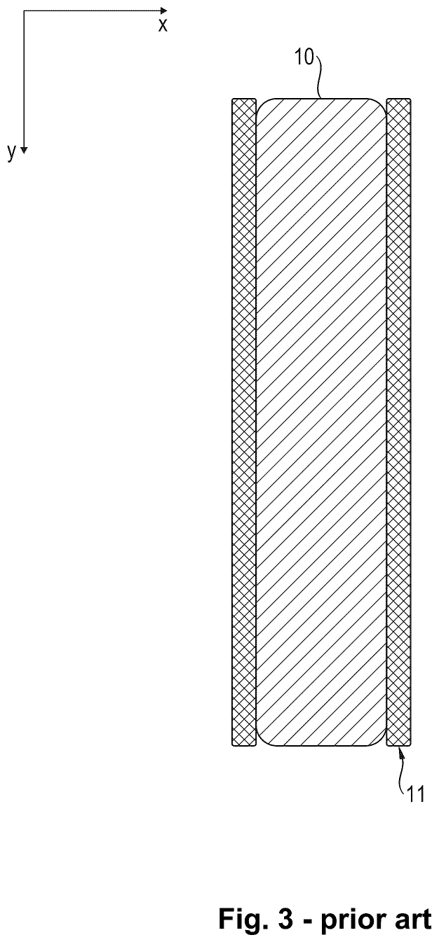

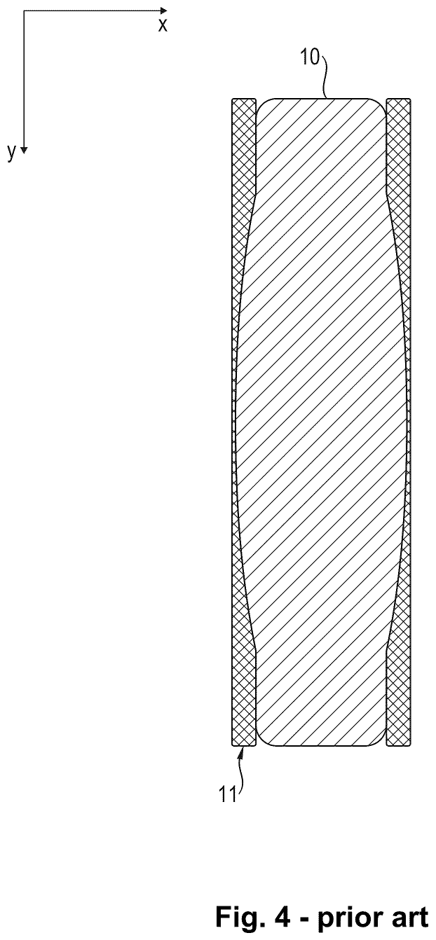

FIGS. 1 and 2 show the longitudinal section of a conventional HVB in the delivery state and at the end of its life. Pressure pads (11) are arranged between the individual cells (10) of the HVB, for both mechanical stabilization and thermal insulation. However, as is readily apparent from the detailed illustrations according to FIG. 3 and FIG. 4, these conventional crushing pads (11) experience significant material fatigue over the life of the HVB, which reduces their biasing force and thus severely impairs the mechanical and electrical integrity of the overall system.

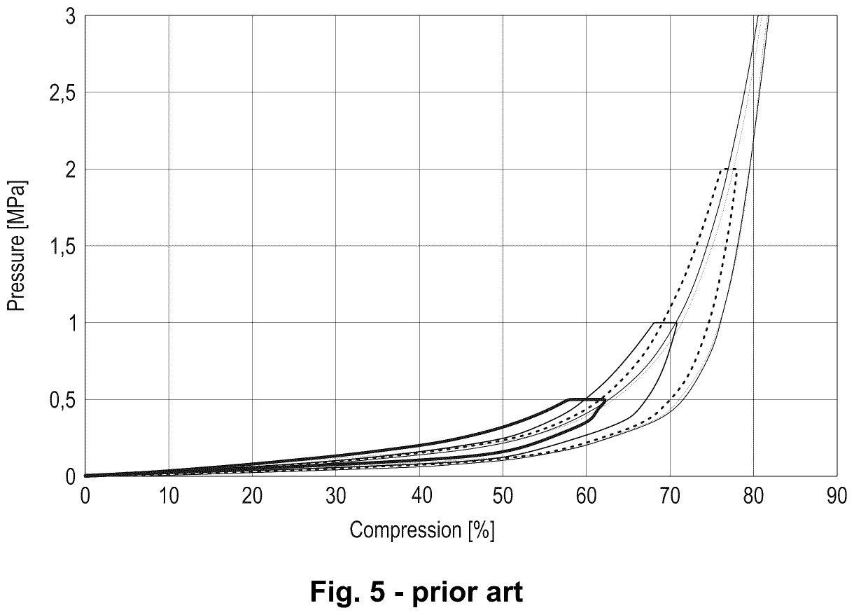

FIG. 5 illustrates the correlation of the pressure exerted by the conventional crushing pad (11) with its relative compression, using a series of curves obtained over six test cycles. It is apparent that as compression increases, the pressure increases. However, the curve changes with each repetition of the experiment, because the elastomer settles with increasing compression.

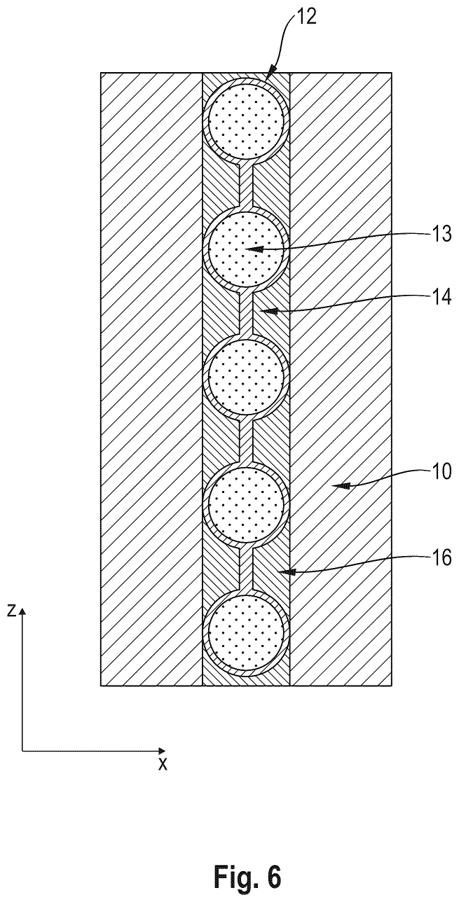

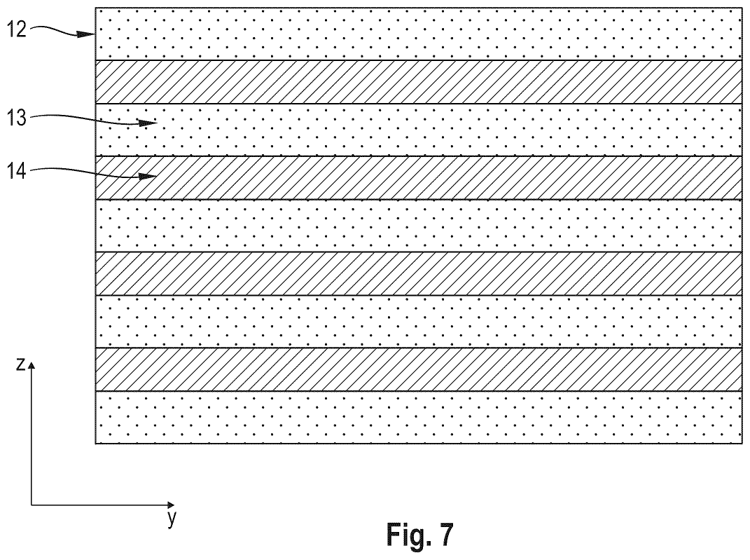

FIGS. 6 and 7 show the transverse and longitudinal section of a crushing pad according to the invention. It consists of an aluminum composite foil (12) which is divided into a plurality of tubular compartments by means of sealing seams (14). These chambers are filled with air or another gas (13) and thus form an air cushion. The sealing seams (14) additionally define channels that allow for an efficient flow of the coolant (16) between the cells (10).

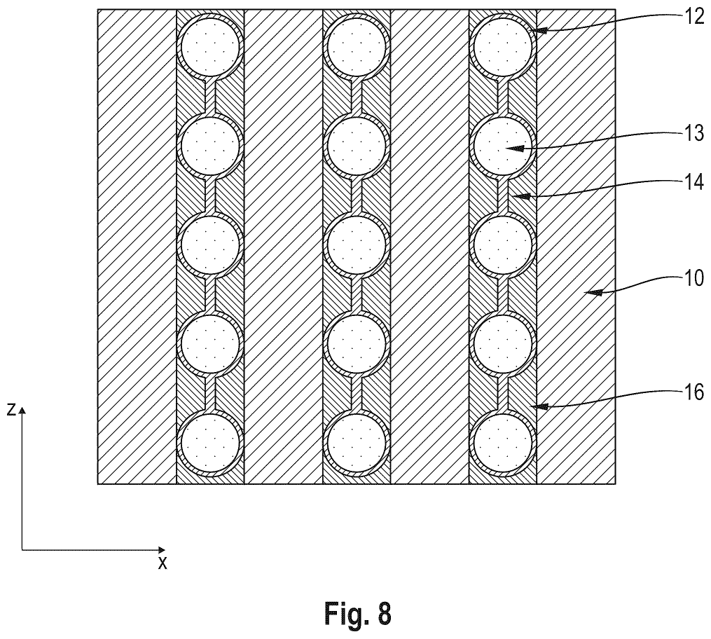

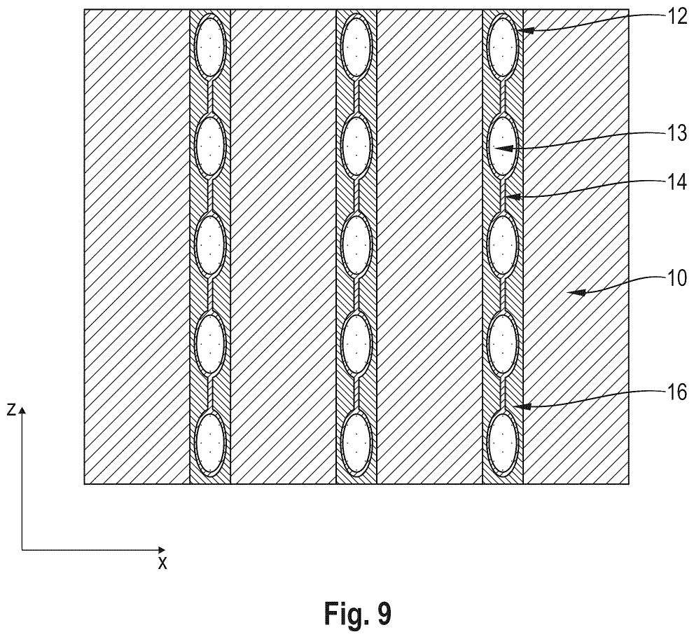

FIGS. 8 and 9 show the longitudinal section of a HVB with crushing pads according to the invention in the delivery state and at the end of life, respectively, analogously to FIGS. 1 and 2. It is apparent that the air cushions maintain their original shape and functionality to a large extent even after a long service time. This is due to the controlled and repeatable compression of the air cushions, which is based on the ideal gas equation and allows for a precise adjustment of the compressibility.

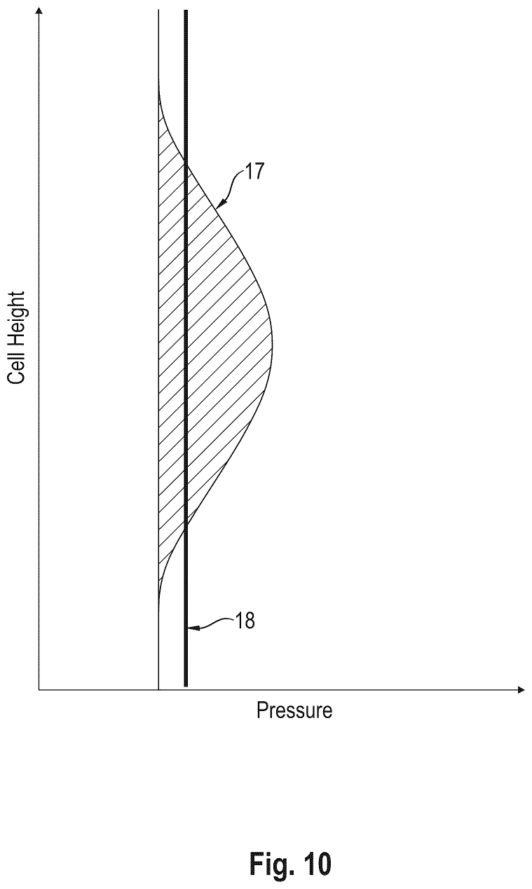

In a common coordinate system, FIG. 10 contrasts the pressure distribution of a conventional crushing pad (17) against a pad (18) filled with air according to the invention. It can be seen that the air cushion allows for a significantly more homogeneous pressure distribution over the entire surface of the pad. This is due to the global pressure equalization created by the connection of the individual air chambers.

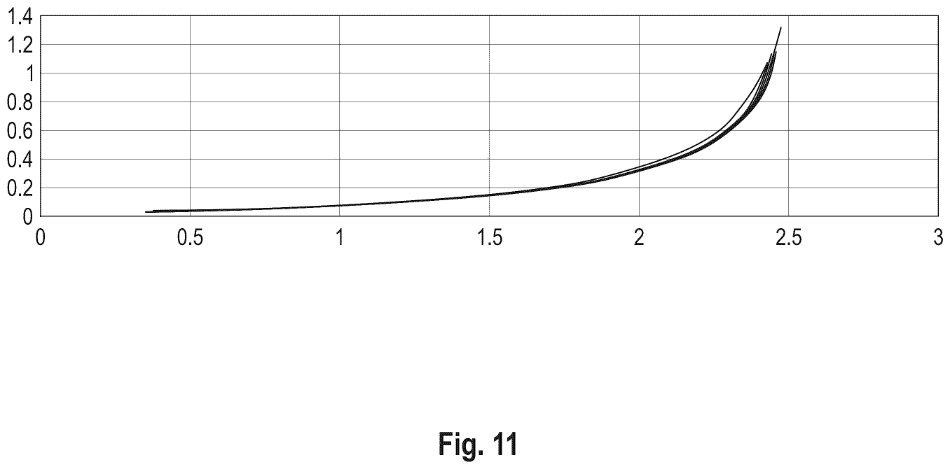

FIG. 11 shows results of long-term tests over 1,000 cycles. FIG. 11 illustrates the correlation of the pressure exerted by the pad according to the invention in megapascals with its thickness in millimeters. It is apparent that this curve remains largely unchanged, even with repeated compression and decompression.

### LIST OF REFERENCE SIGNS

| Reference | |
|---|---|
| sign | Description |
| 10 | Cell |
| 11 | Crushing pad |
| 12 | (Aluminum) composite foil |
| 13 | Air, gas |
| 14 | Sealing seam |
| 16 | Coolant |
| 17 | Pressure distribution of |
| | conventional cell intermediate material |
| 18 | Pressure distribution of crushing |
| | pad according to invention |

1. A high-voltage battery comprising:
a plurality of cells; and
at least one crushing pad arranged between the plurality of cells, wherein the crushing pad is composed of an aluminum composite foil and includes a plurality of conduits formed in the aluminum composite foil.

2. The high-voltage battery according to claim 1, wherein the conduits are configured to contain a gas mixture.

3. The high-voltage battery according to claim 1, wherein the composite foil further comprises sealing seams extending between adjacent conduits of the plurality of conduits, and wherein the sealing seams run parallel between the conduits.

4. The high-voltage battery according to claim 3, wherein the crushing pad is structured so that channels for guiding coolant between adjacent cells are formed on both sides of the crushing pad, wherein the channels extend along the sealing seams and between the adjacent conduits.

5. The high-voltage battery according to claim 4, wherein the cells have a matching height perpendicular to the conduits, and the conduits are fluidly connected to each other such that the crushing pad has a uniform pressure distribution across the height.

6. The high-voltage battery according to claim 4, wherein each conduit has a cross section that is either circular or ovular.

7. A motor vehicle comprising the high-voltage battery according to claim 1.

8. A method of manufacturing a high-voltage battery having a plurality of cells and at least one crushing pad arranged between the plurality of cells, wherein the crushing pad is composed of an aluminum composite foil and includes a plurality of conduits formed in the aluminum composite foil, the method comprising the steps of:
stacking the at least one crushing pad between two cells of the plurality of cells; and
filling the conduits with gas until the crushing pad reaches an internal pressure such that the crushing pad exerts a defined biasing force on the two cells.

9. A method of using a high-voltage battery having a plurality of cells and at least one crushing pad arranged between the plurality of cells, wherein the crushing pad is composed of an aluminum composite foil and includes a plurality of conduits formed in the aluminum composite foil, wherein the crushing pad is structured so that channels for guiding coolant between adjacent cells are formed on both sides of the crushing pad, wherein the channels extend along the sealing seams and between the adjacent conduits, said method comprising:
passing the coolant along the cells and through the channels, and
compressing the crushing pad conduits in response to swelling of the cells.

10. The method according to claim 9, wherein the high-voltage battery is immersion-cooled.
